(19) United States
(12) Patent Application Publication
(10) Pub. No.: US 2025/0035767 A1
(43) Pub. Date: Jan. 30, 2025

(54) POSITIONING SYSTEM AND VEHICLE INCLUDING POSITIONING SYSTEM, AND POSITIONING METHOD

(71) Applicant: Murata Manufacturing Co., Ltd., Nagaokakyo-shi (JP)

(72) Inventor: Katsuhisa KASHIWAGI, Nagaokakyo-shi (JP)

(73) Assignee: Murata Manufacturing Co., Ltd., Nagaokakyo-shi (JP)

(21) Appl. No.: 18/909,957

(22) Filed: Oct. 9, 2024

Related U.S. Application Data
(63) Continuation of application No. PCT/JP2023/015519, filed on Apr. 18, 2023.

(30) Foreign Application Priority Data
Apr. 26, 2022 (JP) 2022-072710

(51) Int. Cl. G01S 13/42; G01S 13/00; G01S 13/58

(52) U.S. Cl. CPC G01S 13/42; G01S 13/003; G01S 13/58

(57) ABSTRACT

A positioning system includes a transceiver and a signal processing unit. The signal processing unit acquires a plurality of antenna data from the transceiver, the antenna data being obtained by radio waves being transmitted and received between transmitting antennas and receiving antennas. In angle estimation processing of the target by employing an Annihilating Filter method, the signal processing unit generates a convolution matrix by stacking the plurality of antenna data in a row direction of a matrix and combining the antenna data, and determines a filter coefficient vector from simultaneous equations expressed by using a matrix product of the convolution matrix and the filter coefficient vector. The signal processing unit calculates a phase difference between antennas from the determined filter coefficient vector and performs an operation to estimate an arrival angle of the reflected wave from the target.

### CROSS-REFERENCE TO RELATED APPLICATIONS

The present application is a continuation application of PCT International Application No. PCT/JP2023/015519 filed on Apr. 18, 2023, designating the United States of America, which is based on and claims priority to Japanese patent application JP 2022-072710, filed Apr. 26, 2022. The entire disclosures of the above-identified applications, including the specifications, the drawings, and the claims are incorporated herein by reference in their entirety.

### BACKGROUND

In general, there has been a millimeter-wave radar system as a positioning system including a plurality of transmitters/receivers to determine a target position. In the millimeter-wave radar system, a radar chip that acts as a master and a radar chip that acts as a slave are cascading-connected, both the radar chips operating in synchronization. The radar chip acting as the master and the radar chip acting as the slave are phase-synchronized by a signal in a millimeter-wave band, which is generated in a PLL circuit inside the radar chip acting as the master, being shared by the radar chip acting as the slave by using wiring formed on a printed circuit board. The phase synchronization causes each of the radar chips to operate in a multi-static manner, and an increase in an antenna aperture length improves target positioning precision.

### SUMMARY

### Solution to Problem

Hence, with the present disclosure, a positioning system is configured that includes:
a plurality of transmitters/receivers having a plurality of transmitting antennas for transmitting radio waves and a plurality of receiving antennas for receiving reflected waves from a target; and
a signal processing unit for estimating an angle of the target by employing an Annihilating Filter method (hereinafter referred to as an AF method) that uses an annihilating filter,
the signal processing unit
   generates a convolution matrix by stacking a plurality of antenna data in a row direction of a matrix and combining the antenna data,
   determines a filter coefficient vector from simultaneous equations expressed by using a matrix product of the convolution matrix and a filter coefficient vector of a transfer function of the annihilating filter, with the filter coefficient vector being unknown,
   calculates a phase difference between antennas from the filter coefficient vector that is determined, and
performs an operation to estimate an arrival angle of the reflected wave from the target, based on the phase difference between the antennas that is calculated.

In addition, in signal processing for estimating an angle of a target by employing an AF method that uses an annihilating filter, with the present disclosure, a positioning method is configured that includes steps of:
generating a convolution matrix by stacking a plurality of antenna data in a row direction of a matrix and combining the antenna data, the antenna data being obtained from a plurality of transmitting antennas for transmitting radio waves and from a plurality of receiving antennas for receiving reflected waves from the target, the plurality of transmitting antennas and the plurality of receiving antennas being included in each of a plurality of transmitters/receivers;
determining a filter coefficient vector from simultaneous equations expressed by using a matrix product of the convolution matrix and a filter coefficient vector of a transfer function of the annihilating filter, with the filter coefficient vector being unknown;
calculating a phase difference between antennas from the filter coefficient vector that is determined; and
performing an operation to estimate an arrival angle of the reflected wave from the target, based on the phase difference between the antennas that is calculated.

According to the configuration, by determining a target position with the plurality of transmitters/receivers, the plurality of antenna data, which is more than antenna data obtained with a single transmitter/receiver, can be obtained. In angle estimation processing of the target by using the AF method, stacking the plurality of antenna data in the row direction of the convolution matrix generates a convolution matrix in which the plurality of antenna data is combined. Therefore, a number of simultaneous equations expressed by using a matrix product of the convolution matrix and a filter coefficient vector is larger than that of simultaneous equations expressed by using a convolution matrix of the antenna data obtained with the single transmitter/receiver. Consequently, the filter coefficient vector obtained by solving the simultaneous equations is expressed with high precision. Therefore, a phase difference between the antennas of the receiving antennas is calculated with high precision from the filter coefficient vector expressed with high precision. Consequently, estimation of the arrival angle of the reflected wave from the target by using the phase difference between the antennas makes it possible to estimate the angle of the target with high precision and high resolution by using the plurality of transmitters/receivers.

The present disclosure describes a method for implementing the above system and a positioning apparatus for implementing the method.

In addition, with the present disclosure, a vehicle is configured that includes the positioning system described above.

According to the configuration, a vehicle can include the positioning system that can estimate an angle of a target with high precision and high resolution by using the plurality of transmitters/receivers.

As a consequence, according to the present disclosure, it is possible to provide a positioning system that can estimate an angle of a target with high precision and high resolution by using a plurality of transmitters/receivers without using wiring or cables, and a vehicle including the positioning system, as well as a positioning method.

### BRIEF DESCRIPTION OF DRAWINGS

FIG. 1 is a block diagram illustrating a schematic configuration of a positioning system according to a first exemplary embodiment of the present disclosure.

FIG. 2 is a graph explaining a transmission signal, a reception signal, and an IF signal in the positioning system according to the first exemplary embodiment.

FIG. 3 is a diagram illustrating a schematic configuration of a positioning system including more radars, according to the first exemplary embodiment.

FIG. 4 is a flowchart illustrating an outline of processing of a general positioning system.

FIG. 5 is a graph for explaining distance estimation to a target that is performed by the positioning system according to the first exemplary embodiment.

FIG. 6 is a flowchart illustrating an outline of processing of the positioning system according to the first exemplary embodiment.

FIG. 7 is a block diagram illustrating a schematic configuration of a positioning system according to a second exemplary embodiment of the present disclosure.

FIG. 8 is a graph for explaining synchronization performed by the positioning system according to the second exemplary embodiment.

FIG. 9 is a flowchart illustrating an outline of processing of the positioning system according to the second exemplary embodiment.

FIG. 10 is a diagram illustrating a schematic configuration of a positioning system including more radars, according to the second exemplary embodiment.

FIG. 11 is a graph explaining arrangement of antennas after MIMO processing performed for two radars of the positioning system according to the second exemplary embodiment.

FIG. 12 is a diagram illustrating simulation results of RMSE (Root Mean Squared Error) when a change is made to a difference in installation angles of two targets estimated by the positioning system according to the second exemplary embodiment, as well as a relationship between the radars and the targets at that time.

FIG. 13 is a graph explaining arrangement of antennas after MIMO processing performed for two radars of a positioning system according to a third exemplary embodiment of the present disclosure.

FIG. 14 is a graph for explaining the arrangement of the antennas after the MIMO processing in the positioning system according to the third exemplary embodiment.

FIG. 15 is a graph illustrating AD and the number of the antennas after the MIMO processing in the positioning system according to the third exemplary embodiment.

FIG. 16 is a diagram explaining effects of the positioning systems according to the second and third exemplary embodiments.

FIG. 17 is a diagram explaining a vehicle including the positioning system according to each of the exemplary embodiments.

### DETAILED DESCRIPTION

In the positioning system, however, in order to achieve synchronization between a plurality of transmitters/receivers (radar chips), wiring for propagating high-frequency signals in millimeter-wave bands (30 to 300 GHz) is necessary to connect the respective transmitters/receivers. There is no problem when the high frequency signals in the millimeter-wave bands are propagated, as far as the respective transmitters/receivers are formed close to each other on a same printed circuit board and the wiring is short. However, when a distance between the respective transmitters/receivers is slightly large, a special cable is needed that does not cause any loss or phase variation when the high frequency signals in the millimeter-wave bands are propagated.

An object of the present disclosure is to provide a positioning system that can estimate an angle of a target with high precision and high resolution by using a plurality of transmitters/receivers without using such wiring or cables, and a vehicle including the positioning system, as well as a positioning method.

In the following, a description will be given of exemplary embodiments for implementing a positioning system of the present disclosure and a vehicle including the positioning system.

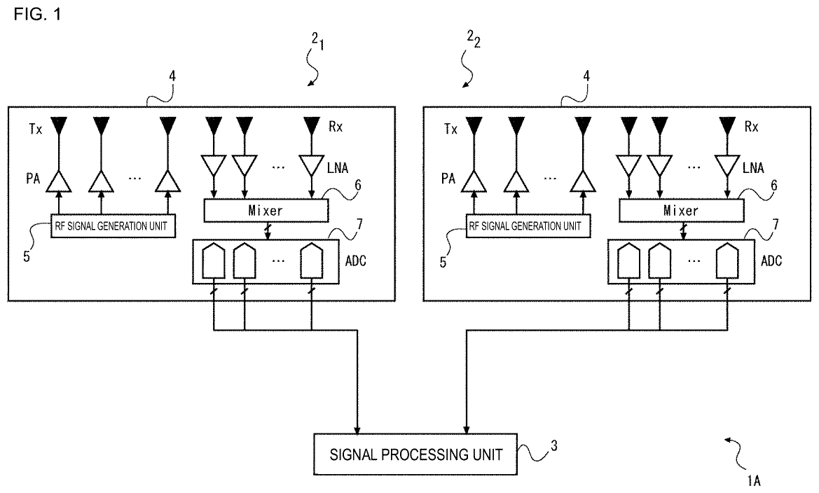

FIG. 1 is a block diagram illustrating a schematic configuration of a positioning system 1A according to a first exemplary embodiment of the present disclosure.

The positioning system 1A includes a first radar 2₁, a second radar 2₂, and a signal processing unit 3. The first radar 2₁ and the second radar 2₂ may be collectively referred to as radars 2.

The first radar 2₁ and the second radar 2₂ are MIMO (Multiple-Input Multiple-Output) radars 2, each operating according to an FMCW (Frequency Modulated Continuous Wave) method or an FCM (Fast-Chirp Modulation) method, which constitute a plurality of transmitters/receivers having a same configuration. The first radar 2₁ and the second radar 2₂ are each provided as a transmitter/receiver 4. A plurality of transmitting antennas Tx and a plurality of receiving antennas Rx are provided in the transmitter/receiver 4. The transmitting antennas Tx and the receiving antennas Rx are formed at equal intervals to each other.

An RF signal generated by an RF signal generation unit 5 is amplified by a power amplifier PA and transmitted as a transmission signal from the transmitting antenna Tx. The signal transmitted from the transmitting antenna Tx is a radio wave and reflected at a target. The receiving antenna Rx receives a reflected wave from the target. The reflected wave received by the receiving antenna Rx is amplified by a low noise amplifier LNA and output to a mixer 6. The mixer 6 mixes the transmission signal and a reception signal to generate an intermediate frequency signal (IF signal). The IF signal is converted to a digital signal by an ADC (analog-to-digital converter) 7 and output to the signal processing unit 3.

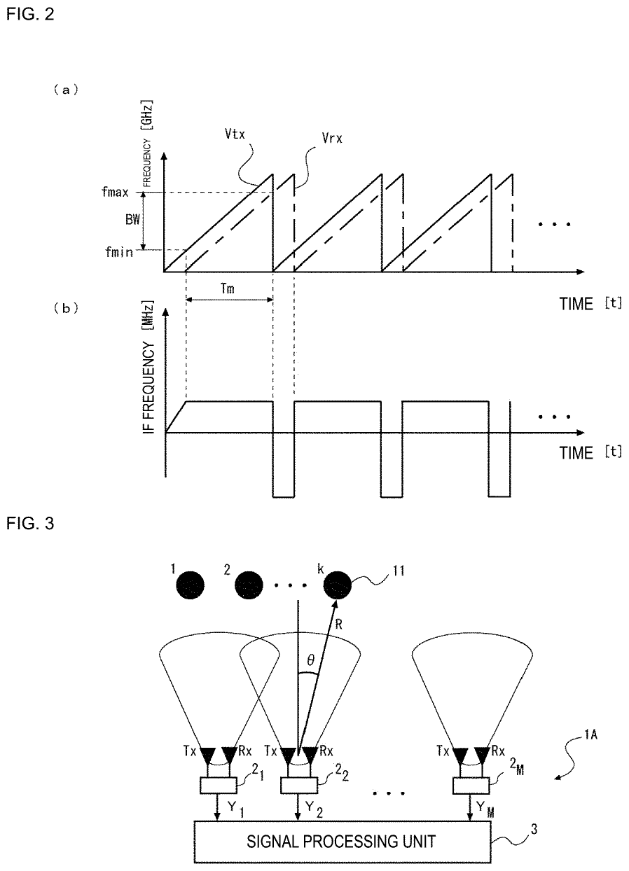

As illustrated in a graph of FIG. 2(a), if a transmission signal Vtx transmitted from the transmitting antenna Tx and a reception signal Vrx received by the receiving antenna Rx are expressed as chirp signals, the IF signal is expressed as illustrated in FIG. 2(b). In the graph of FIG. 2(a), the horizontal axis represents time [t] and the vertical axis represents a chirp frequency [GHz]. In the graph of FIG. 2(b), the horizontal axis represents the time [t] and the vertical axis represents an IF frequency [MHz].

In this case, as illustrated in the graph of FIG. 2(a), a chirp period of the IF signal sampled by the ADC 7 is expressed as Tm, a bandwidth of the chirp signal is expressed as BW, a lower limit frequency of the bandwidth BW is expressed as fmin, and an upper limit frequency is expressed as fmax. At this time, if an initial phase of the transmission signal Vtx is φ1 and amplitudes of the transmission signal Vtx and the reception signal Vrx are Atx and Arx, respectively, the transmission signal Vtx and the reception signal Vrx are expressed by the expressions (1) and (2) below:

$$\begin{matrix}[ MATHEMATICAL EXPRESSION 1 ] & \\ {V}_{tx} = {A}_{tx} cos ( {ω}_{tx} t + {ϕ}_{1} ) & ( 1 )\end{matrix}$$

$${V}_{r x} = {A}_{r x} cos [ {ω}_{tx} ( t - \frac{2 R}{c} ) + {ϕ}_{1} ] \qquad ( 2 )$$

The MIMO radars virtually form N antennas (where N is an integer equal to or larger than 2). A phase φangle(n) of the IF signal for an arrival angle θ of the reflected wave to the n-th antenna of the N antennas is expressed by the following expression (3) where an interval of the N antennas disposed at equal intervals is d, a chirp center frequency fc=fmin+BW/2, velocity of light is c, and a distance to a target 11 is R as illustrated in FIG. 3. Note that FIG. 3 illustrates the positioning system 1A having M radars 2 (where M is an integer equal to or larger than 2).

$$\begin{matrix}[ MATHEMATICAL EXPRESSION 2 ] & \\ {ϕ}_{angle} ( n ) = \frac{nd sin θ}{c} {f}_{c} & ( 3 )\end{matrix}$$

Using the expression (3), an IF signal VIF(t,n) at the time t that is obtained from the reception signal of the antenna with the antenna number n is expressed by the following expression (4):

$$\begin{matrix}[ MATHEMATICAL EXPRESSION 3 ] & \\ {V}_{IF} ( t , n ) = \frac{{A}_{tx} \cdot {A}_{rx}}{2} cos 2 π [ \frac{2 RBW}{cTm} t + \frac{2 R {f}_{min}}{c} + \frac{nd sin θ}{c} {f}_{c} ] & ( 4 )\end{matrix}$$

The signal processing unit 3 includes a personal computer (PC), an ECU (Electronic Control Unit) mounted in a vehicle, or the like.

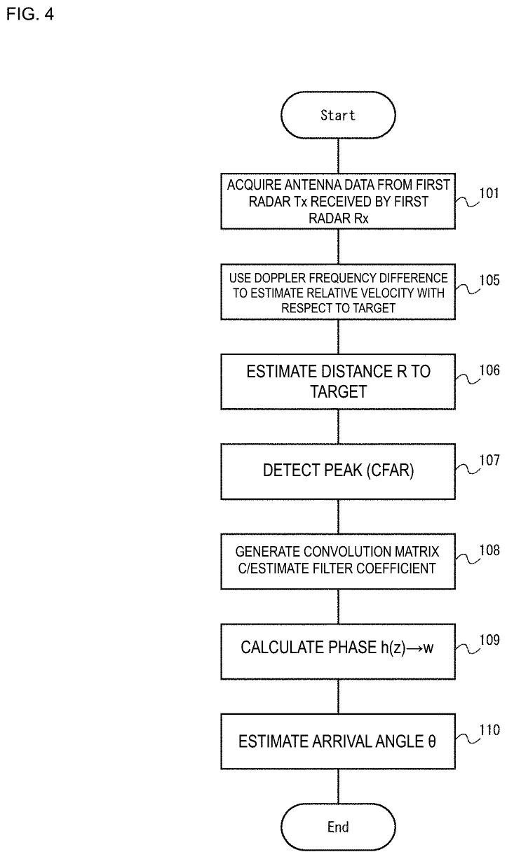

Before a description of signal processing of the signal processing unit 3 in the positioning system 1A of the present exemplary embodiment, a description will be given of an outline of signal processing by a signal processing unit in a general positioning system, with reference to a flowchart illustrated in FIG. 4.

The signal processing unit acquires antenna data Y₁ that is transmitted from the transmitting antenna Tx of the first radar 2₁ and received by the receiving antenna Rx of the first radar 2₁ (See step 101 in FIG. 4).

Next, by FFT (fast Fourier transform)-processing the IF signal, the signal processing unit calculates a relative velocity of the positioning system 1A with respect to the target 11 by using a Doppler frequency difference from a Doppler shift of the transmission signal Vtx and the reception signal Vrx (see step 105). Then, the signal processing unit 3 calculates the distance R to the target 11 (see step 106). The relative velocity and the distance R may be calculated by using, for example, a general method such as FFT, a MUSIC method, an ESPRIT method, or the like.

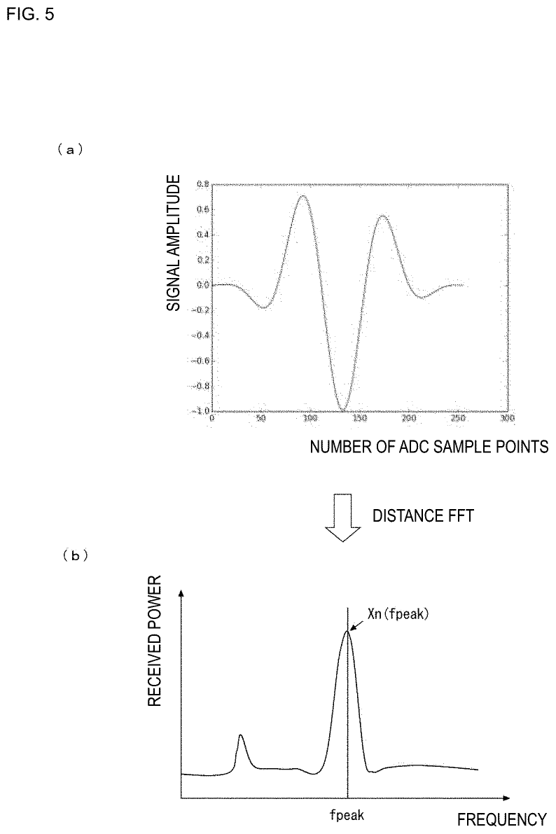

For simplicity, if the target 11 is a stationary object and a first-order partial differential of a term (2Rfmin/c) expressing the distance R of the expression (4) is 0 (velocity=0), an amplitude x(t,n) of the IF signal at the time t obtained from the reception signal of the antenna with the antenna number n is expressed from the equation (4) to the following equation (5). A waveform of the reception signal is illustrated in the graph of FIG. 5(a). The horizontal axis of FIG. 5(a) represents the number of ADC sample points by the ADC 7, and the vertical axis represents a signal amplitude of the reception signal.

$$\begin{matrix}[ MATHEMATICAL EXPRESSION 4 ] & \\ x ( t , n ) = \frac{{A}_{tx} \cdot {A}_{r x}}{2} cos 2 π [ \frac{2 RBW}{cTm} t + \frac{nd sin θ}{c} {f}_{c} ] & ( 5 )\end{matrix}$$

The signal processing unit performing distance FFT processing on the reception signal, as illustrated in the graph of FIG. 5(b), a reception signal Xn(fpeak) is obtained at a peak frequency fpeak. The horizontal axis of the graph of FIG. 5(b) represents a frequency, and the vertical axis represents received power. A phase of the reception signal Xn(fpeak) is (ndsinθ/c)·fc, as illustrated in the equation (5).

After calculating the relative velocity and the distance R, the signal processing unit performs CFAR (constant false alarm rate) processing for detecting the peak of the IF signal (see step 107) and detects the target 11 as a target object in the presence of background noise.

Next, the signal processing unit performs the angle estimation processing of the target 11 by employing the AF method that uses the annihilating filter. In the angle estimation processing, the signal processing unit first generates a convolution matrix C from the antenna data Y₁ obtained in step 101 and estimates a filter coefficient vector H of a transfer function of the annihilating filter (see step 108).

In general, if the antenna data in the n-th antenna of the N antennas is x expressed in the following equation (6) and the antenna data Y₁ acquired in step 101 is expressed in the following expression (6), the convolution matrix C is expressed by the following expression (7), with K as an estimated wave number:

$$\begin{matrix}[ MATHEMATICAL EXPRESSION 5 ] & \\ \begin{matrix}X = [ {X}_{1} , {X}_{2} , … , {X}_{N} ] \\ {Y}_{1} = [ {X}_{1} ( {f}_{peak} ) , {X}_{2} ( {f}_{peak} ) , … , {X}_{N} ( {f}_{peak} )\end{matrix} \} & ( 6 )\end{matrix}$$

$$C = [ \begin{matrix}{X}_{K + 1} ( {f}_{peak} ) & {X}_{K} ( {f}_{peak} ) & … & {X}_{2} ( {f}_{peak} ) & {X}_{1} ( {f}_{peak} ) \\ {X}_{K + 2} ( {f}_{peak} ) & {X}_{K + 1} ( {f}_{peak} ) & … & {X}_{3} ( {f}_{peak} ) & {X}_{2} ( {f}_{peak} ) \\ ⋮ & ⋮ & ⋱ & ⋮ & ⋮ \\ {X}_{N} ( {f}_{peak} ) & {X}_{N - 1} ( {f}_{peak} ) & … & {X}_{N - K + 1} ( {f}_{peak} ) & {X}_{N - K} ( {f}_{peak} )\end{matrix} ] \qquad ( 7 )$$

If the filter coefficients in a transfer function h (z) of the annihilating filter are h₀, h₁, . . . , hₖ, the filter coefficient vector H is expressed by the following expression (8). The filter coefficient vector H is estimated by solving simultaneous equations in which an L2 norm of a matrix product of the convolution matrix C and the filter coefficient vector H is at a minimum, with the filter coefficient vector H being an unknown, as illustrated in the following expression (9), that is, by determining the filter coefficient vector H. Here, H^{T} is the transposed filter coefficient vector H.

$$\begin{matrix}[ MATHEMATICAL EXPRESSION 6 ] & \\ H = [ {h}_{0} , {h}_{1} , … , {h}_{K} ] & ( 8 )\end{matrix}$$

$${‖ {CH}^{T} ‖}_{2} = 0 \qquad ( 9 )$$

Next, the signal processing unit performs phase calculation by using a polynomial equation illustrated in the following expression (10), from the determined filter coefficient vector H (see step 109). In the phase calculation, calculation is performed to determine a solution z=Zₖ (here, 1≤k≤K) of the polynomial equation where the transfer function h (z) is 0.

$$\begin{matrix}[ MATHEMATICAL EXPRESSION 7 ] & \\ h ( z ) = {h}_{0} {z}^{K} + {h}_{1} {z}^{K - 1} + … + {h}_{K} = {\prod }_{k = 1}^{K} ( z - {z}_{k} ) = 0 & ( 10 )\end{matrix}$$

The solution zₖ is a phase difference wₖ between antennas. Here, zₖ and wₖ have a relationship illustrated in the following expression (11).

$$\begin{matrix}[ MATHEMATICAL EXPRESSION 8 ] & \\ {z}_{k} = {e}^{{jw}_{k}} & ( 11 )\end{matrix}$$

Next, the signal processing unit calculates, from the phase difference between the antennas described above, an arrival angle θₖ of the reflected wave from the k-th target 11 by the following expression (12) (see step 110). As illustrated in FIG. 3, the angle θₖ is an angle at which the positioning system 1A is located with respect to the k-th target 11.

$$\begin{matrix}[ MATHEMATICAL EXPRESSION 9 ] & \\ {θ}_{k} = {Sin}^{- 1} ( \frac{λ {Tan}^{- 1} ( {z}_{k} \cdot Im / {z}_{k} \cdot Re )}{2 π d} ) & ( 12 )\end{matrix}$$

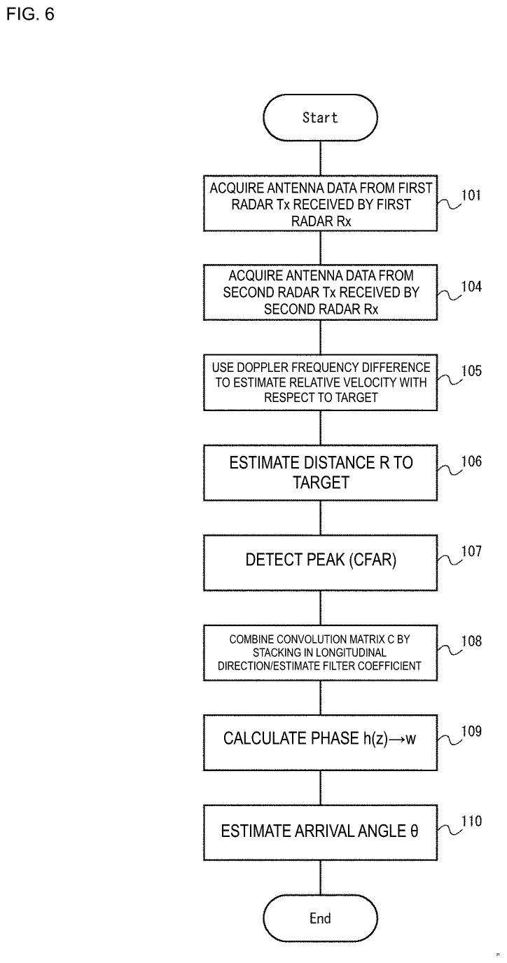

Next, a description will be given of an outline of signal processing by the signal processing unit 3 in the positioning system 1A of the present exemplary embodiment, with reference to the flowchart illustrated in FIG. 6. Note that in the flowchart in FIG. 6, the same or corresponding processing as that in the flowchart illustrated in FIG. 4 will be described with the same reference numeral.

The signal processing unit 3 in the positioning system 1A of the present exemplary embodiment first acquires the antenna data Y₁ transmitted from the transmitting antenna Tx of the first radar 2₁ and received by the receiving antenna Rx of the first radar 2₁ (see step 101 in FIG. 6). Then, the signal processing unit 3 acquires antenna data Y₂ transmitted from the transmitting antenna Tx of the second radar 2₂ and received by the receiving antenna Rx of the second radar 2₂ (see step 104).

Next, similarly to the processing by the general signal processing unit illustrated in the flowchart of FIG. 4, the signal processing unit performs the processing in steps 105 to 107. That is, in step 105, the signal processing unit 3 calculates the relative velocity of the positioning system 1A with respect to the target 11 by using the Doppler frequency difference from the Doppler shift of the transmission signal Vtx and the reception signal Vrx. Then, in step 106, the signal processing unit 3 calculates the distance R to the target 11. Then, in step 107, the signal processing unit 3 performs the CFAR processing to detect the peak of the IF signal.

Next, in step 108, the signal processing unit 3 generates the convolution matrix C by stacking (piling up) the plurality of antenna data Y₁ and Y₂ in a row direction of a matrix and combining the plurality of antenna data Y₁ and Y₂, the plurality of antenna data Y₁ and Y₂ having different initial phases and being acquired in steps 101 and 104. Then, the signal processing unit 3 estimates the filter coefficient vector H of the transfer function of the annihilating filter. At this time, the signal processing unit 3 performs an operation by estimating the number of waves of the reflected wave coming from the target 11 as K. As such, in the AF method, it is possible to stack the antenna data Y₁ and Y₂ having the different initial phases in the convolution matrix C when estimating the angle of the target 11.

For example, suppose that the antenna data Y₁ and Y₂ expressed in the following expression (13) is obtained in steps 101 and 104.

$$\begin{matrix}[ MATHEMATICAL EXPRESSION 10 ] & \\ \begin{matrix}{Y}_{1} = [ {X}_{1} ( {f}_{peak} ) , {X}_{2} ( {f}_{peak} ) , … , {X}_{N} ( {f}_{peak} ) ] \\ {Y}_{2} = [ {X}_{N + 1} ( {f}_{peak} ) , {X}_{N + 2} ( {f}_{peak} ) , … , {X}_{2 N} ( {f}_{peak} ) ]\end{matrix} \} & ( 13 )\end{matrix}$$

In this case, as illustrated in the following expression (14), the convolution matrix C is generated by stacking the respective antenna data Y₁ and Y₂ in the row direction of the matrix.

$$\begin{matrix}[ MATHEMATICAL EXPRESSION 11 ] & \\ C = [ \begin{matrix}{X}_{K + 1} ( {f}_{peak} ) & {X}_{K} ( {f}_{peak} ) & … & {X}_{2} ( {f}_{peak} ) & {X}_{1} ( {f}_{peak} ) \\ {X}_{K + 2} ( {f}_{peak} ) & {X}_{K + 1} ( {f}_{peak} ) & … & {X}_{3} ( {f}_{peak} ) & {X}_{2} ( {f}_{peak} ) \\ ⋮ & ⋮ & ⋱ & ⋮ & ⋮ \\ {X}_{N} ( {f}_{peak} ) & {X}_{N - 1} ( {f}_{peak} ) & … & {X}_{N - K + 1} ( {f}_{peak} ) & {X}_{N - K} ( {f}_{peak} ) \\ {X}_{N + K + 1} ( {f}_{peak} ) & {X}_{N + K} ( {f}_{peak} ) & … & {X}_{N + 2} ( {f}_{peak} ) & {X}_{N + 1} ( {f}_{peak} ) \\ {X}_{N + K + 2} ( {f}_{peak} ) & {X}_{N + K + 1} ( {f}_{peak} ) & … & {X}_{N + 3} ( {f}_{peak} ) & {X}_{2} ( {f}_{peak} ) \\ ⋮ & ⋮ & ⋱ & ⋮ & ⋮ \\ {X}_{2 N} ( {f}_{peak} ) & {X}_{2 N - 1} ( {f}_{peak} ) & … & {X}_{2 N - K + 1} ( {f}_{peak} ) & {X}_{2 N - K} ( {f}_{peak} )\end{matrix} ] \begin{matrix}\} \\ \}\end{matrix} \begin{matrix} \\ \\ {Y}_{1} \\ \\ \\ \\ {Y}_{2} \\ \\ \end{matrix} & ( 14 )\end{matrix}$$

The number of the simultaneous equations expressed in the expression (9) by using the matrix product of the convolution matrix C and the filter coefficient vector H is larger than that of simultaneous equations expressed by using the convolution matrix C of the antenna data obtained with a single radar. Consequently, the filter coefficient vector H obtained by solving the simultaneous equations is expressed with high precision. Therefore, the phase difference wₖ between the antennas is calculated with high precision from the filter coefficient vector H expressed with the high precision. Consequently, in step 109 and step 110, the estimation of the arrival angle θₖ of the reflected wave from the target 11 by using the phase difference wₖ between the antennas makes it possible to estimate the angle of the target with high precision and high resolution by using the plurality of transmitters/receivers.

As such, in the general positioning system, the precision of the simultaneous equations illustrated in the expression (9) deteriorates, because a relation between the estimated number of waves K in the expression (7) and the number of antennas N is an underdetermined problem at K>(N−1)/2. However, in the positioning system 1A according to the present exemplary embodiment, this condition is eased by stacking the antenna data in the row direction of the plurality of rows, which thus improves the precision of estimation. However, the condition is that the target position does not change between acquisition of the respective antenna data. For this reason, no wiring or cables for phase synchronization is needed.

Note that in FIG. 3, antenna data acquired by each of the radars 2₁, 2₂, . . . , 2_{M} at a plurality of points (M points) is collectively expressed as Y₁, Y₂, . . . , Y_{M}. Each of the antenna data Y₁, Y₂, . . . , Y_{M} is expressed by the following expression (15):

$$\begin{matrix}[ MATHEMATICAL EXPRESSION 12 ] & \\ \begin{matrix}{Y}_{1} = [ {X}_{1} ( {f}_{peak} ) , {X}_{2} ( {f}_{peak} ) , … , {X}_{N} ( {f}_{peak} ) ] \\ {Y}_{2} = [ {X}_{N + 1} ( {f}_{peak} ) , {X}_{N + 2} ( {f}_{peak} ) , … , {X}_{2 N} ( {f}_{peak} ) ] \\ ⋮ \\ {Y}_{M} = [ {X}_{( M - 1 ) N + 1} ( {f}_{peak} ) , {X}_{( M - 1 ) N + 2} ( {f}_{peak} ) , … , {X}_{M N} ( {f}_{peak} ) ]\end{matrix} \} & ( 15 )\end{matrix}$$

With the positioning system 1A according to the first exemplary embodiment, the plurality of antenna data Y₁ and Y₂, the number of which is larger than that of the antenna data obtained with the single radar, can be obtained by determining the position of the target 11 by using the plurality of radars 2₁ and 2₂. In the angle estimation processing of the target 11 by using the AF method in steps 108 to 110 in FIG. 6, the convolution matrix C, in which the plurality of antenna data is combined, is generated by stacking the plurality of antenna data Y₁ and Y₂ having the different initial phases in the row direction of the convolution matrix C, as in the expression (14).

Therefore, the number of the simultaneous equations expressed in the expression (9) by using the matrix product of the convolution matrix C and the filter coefficient vector H is larger than that of simultaneous equations expressed by using the convolution matrix C of the antenna data obtained with the single radar. Consequently, the filter coefficient vector H obtained by solving the simultaneous equations is expressed with high precision. Therefore, the phase difference wₖ between the antennas is calculated with high precision, from the filter coefficient vector H expressed with the high precision.

Consequently, the estimation of the arrival angle θₖ of the reflected wave from the target 11 by using the phase difference wₖ between the antennas makes it possible to estimate the angle of the target with high precision and high resolution by using the plurality of transmitters/receivers. As such, in the general positioning system, the precision of the simultaneous equations illustrated in the expression (9) deteriorates, because the relation between the estimated number of waves K in the expression (7) and the number of antennas N is the underdetermined problem at K>(N−1)/2. However, in the positioning system 1A according to the present exemplary embodiment, this condition is eased by stacking the antenna data in the row direction of the plurality of rows, which thus improves the precision of estimation. However, the condition is that the target position does not change between the acquisition of the respective antenna data.

As a result, with the positioning system 1A according to the first exemplary embodiment, it is possible to provide the positioning system 1A that can perform the angle estimation of the arrival angle θₖ of the target 11 with high precision and high resolution by using the plurality of transmitters/receivers without using the wiring or cables. Therefore, an additional circuit for high-frequency synchronization in the millimeter-wave band as in the method of the related art is no longer necessary. This not only reduces power consumption of the positioning system 1A but also eliminates the need for the wiring or cables, which allows for cost reduction of the positioning system 1A.

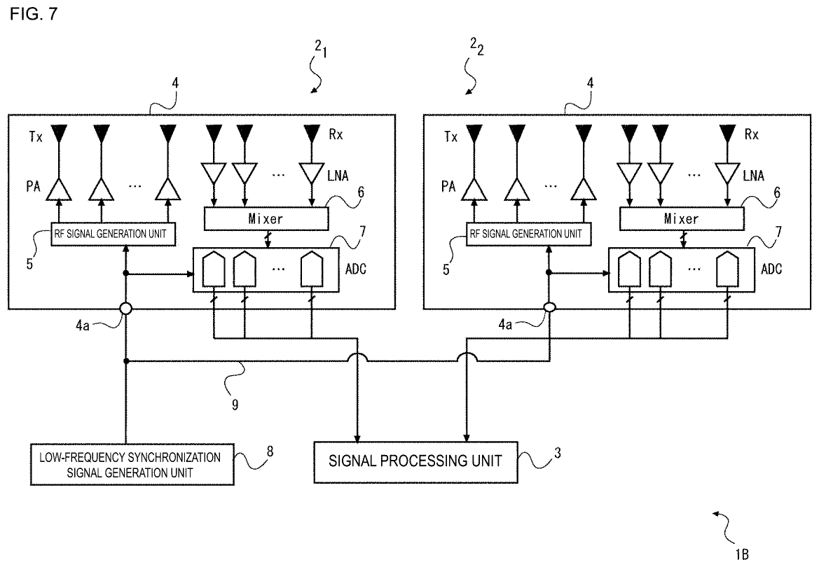

Next, a description will be given of a positioning system according to a second exemplary embodiment of the present disclosure. FIG. 7 is a block diagram illustrating a schematic configuration of a positioning system 1B according to the second exemplary embodiment. In FIG. 7, the same reference numerals are assigned to the same or corresponding parts as those in FIG. 1, and a description thereof will be omitted.

The positioning system 1B according to the second exemplary embodiment differs from the positioning system 1A according to the first exemplary embodiment in that the former includes a low-frequency synchronization signal generation unit 8. The low-frequency synchronization signal generation unit 8 synchronizes signal processing in a frequency band of the IF signal between the respective radars 2₁ and 2₂, where the respective radars 2₁ and 2₂ mix and calculate the transmission signal Vtx and the reception signal Vrx. For any other point, the positioning system 1B is similar to the positioning system 1A according to the first exemplary embodiment.

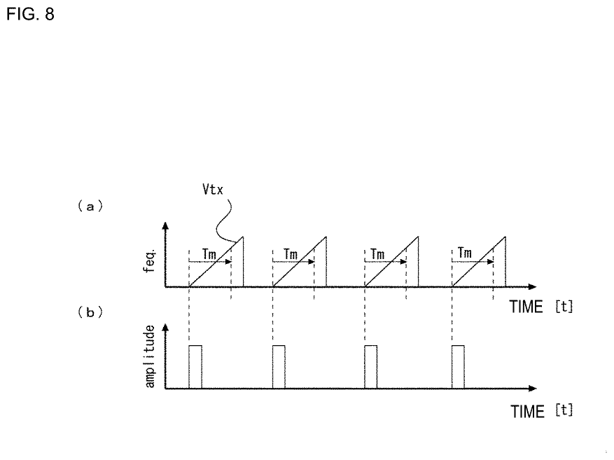

The low-frequency synchronization signal generation unit 8 is connected to a low-frequency synchronization signal input terminal 4a of each of the transmitters/receivers 4 through a cable 9. The low-frequency synchronization signal generation unit 8 generates a low-frequency synchronization signal in the IF frequency band illustrated in the graph of FIG. 8(b), the low-frequency synchronization signal being synchronized with the transmission signal Vtx illustrated in the graph of FIG. 8(a). In FIG. 8, the same reference numerals are assigned to the same or corresponding parts as those in FIG. 2, and a description thereof will be omitted. In addition, in the graph of FIG. 8(a), the horizontal axis represents the time [t], and the vertical axis represents the chirp frequency. In the graph of FIG. 8(b), the horizontal axis represents the time [t], and the vertical axis represents signal intensity.

Low-frequency synchronization signals output from the low-frequency synchronization signal generation unit 8 are provided to the respective radars 2₁ and 2₂, through the cable 9 by way of the low-frequency synchronization signal input terminals 4a of the transmitters/receivers 4 in the respective radars 2₁ and 2₂. The respective radars 2₁ and 2₂ operate synchronously with the low-frequency synchronization signals.

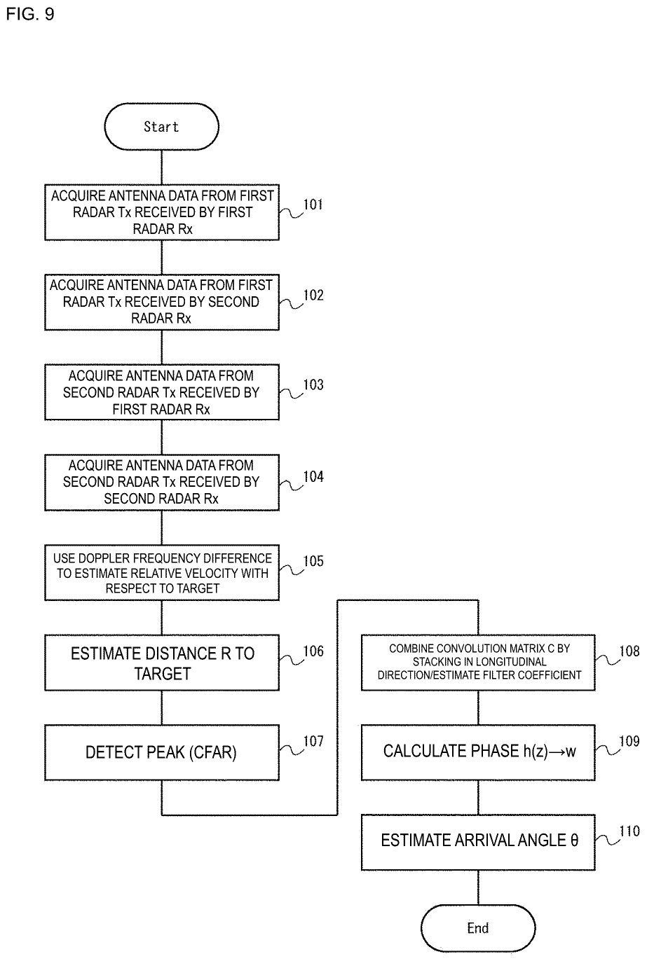

FIG. 9 is a flowchart illustrating an outline of signal processing by the signal processing unit 3 in the positioning system 1B according to the second exemplary embodiment. Note that in the same flowchart, the same reference numeral is assigned to the same or corresponding processing as that in the flowchart illustrated in FIG. 6, and a description thereof will be omitted.

The positioning system 1B according to the second exemplary embodiment differs from the positioning system 1A according to the first exemplary embodiment in that radio waves are transmitted and received between the plurality of transmitting antennas Tx and the plurality of receiving antennas Rx of the plurality of radars 2₁ and 2₂. For any other point, the positioning system 1B is similar to the positioning system 1A according to the first exemplary embodiment.

More specifically, the signal processing by the signal processing unit 3 in the positioning system 1B according to the second exemplary embodiment is to acquire a plurality of antenna data Y₁(1), Y₂(1), Y₁(2), and Y₂(2) in steps 101 to 104 in FIG. 9. That is, the signal processing unit 3 acquires the antenna data Y₁(1) transmitted from the transmitting antenna Tx of the first radar 2₁ and received by the receiving antenna Rx of the first radar 2₁ (see step 101 in FIG. 9). Then, the signal processing unit 3 acquires the antenna data Y₂(1) transmitted from the transmitting antenna Tx of the first radar 2₁ and received by the receiving antenna Rx of the second radar 2₂ (see step 102). Then, the signal processing unit 3 acquires the antenna data Y₁(2) transmitted from the transmitting antenna Tx of the second radar 2₂ and received by the receiving antenna Rx of the first radar 2₁ (see step 103). Then, the signal processing unit 3 acquires the antenna data Y₂(2) transmitted from the transmitting antenna Tx of the second radar 2₂ and received by the receiving antenna Rx of the second radar 2₂ (see step 104).

For example, suppose that the antenna data Y₁(1), Y₂(1), Y₁(2), and Y₂(2) expressed in the following expression (16) is obtained in steps 101 to 104.

$$\begin{matrix}[ MATHEMATICAL EXPRESSION 13 ] & \\ \begin{matrix}{Y}_{1} ( 1 ) = [ {X}_{1} ( {f}_{peak} ) , {X}_{2} ( {f}_{peak} ) , … , {X}_{N} ( {f}_{peak} ) ] \\ {Y}_{1} ( 2 ) = [ {X}_{N + 1} ( {f}_{peak} ) , {X}_{N + 2} ( {f}_{peak} ) , … , {X}_{2 N} ( {f}_{peak} ) ] \\ {Y}_{2} ( 1 ) = [ {X}_{2 N + 1} ( {f}_{peak} ) , {X}_{2 N + 2} ( {f}_{peak} ) , … , {X}_{3 N} ( {f}_{peak} ) ] \\ {Y}_{2} ( 2 ) = [ {X}_{3 N + 1} ( {f}_{peak} ) , {X}_{3 N + 2} ( {f}_{peak} ) , … , {X}_{4 N} ( {f}_{peak} ) ]\end{matrix} \} & ( 16 )\end{matrix}$$

In this case, each of the antenna data Y₁(1), Y₁(2), Y₂(1), and Y₂(2) being stacked in the row direction of a matrix, the convolution matrix C is generated as expressed in the following expression (17):

$$\begin{matrix}[ MATHEMATICAL EXPRESSION 14 ] & \\ C = [ \begin{matrix}{X}_{K + 1} ( {f}_{peak} ) & {X}_{K} ( {f}_{peak} ) & … & {X}_{2} ( {f}_{peak} ) & {X}_{1} ( {f}_{peak} ) \\ {X}_{K + 2} ( {f}_{peak} ) & {X}_{K + 1} ( {f}_{peak} ) & … & {X}_{3} ( {f}_{peak} ) & {X}_{2} ( {f}_{peak} ) \\ ⋮ & ⋮ & ⋱ & ⋮ & ⋮ \\ {X}_{N} ( {f}_{peak} ) & {X}_{N - 1} ( {f}_{peak} ) & … & {X}_{N - K + 1} ( {f}_{peak} ) & {X}_{N - K} ( {f}_{peak} ) \\ {X}_{N + K + 1} ( {f}_{peak} ) & {X}_{N + K} ( {f}_{peak} ) & … & {X}_{N + 2} ( {f}_{peak} ) & {X}_{N + 1} ( {f}_{peak} ) \\ {X}_{N + K + 2} ( {f}_{peak} ) & {X}_{N + K + 1} ( {f}_{peak} ) & … & {X}_{N + 3} ( {f}_{peak} ) & {X}_{2} ( {f}_{peak} ) \\ ⋮ & ⋮ & ⋱ & ⋮ & ⋮ \\ {X}_{2 N} ( {f}_{peak} ) & {X}_{2 N - 1} ( {f}_{peak} ) & … & {X}_{2 N - K + 1} ( {f}_{peak} ) & {X}_{2 N - K} ( {f}_{peak} ) \\ {X}_{2 N + K + 1} ( {f}_{peak} ) & {X}_{2 N + K} ( {f}_{peak} ) & … & {X}_{2 N + 2} ( {f}_{peak} ) & {X}_{2 N + 1} ( {f}_{peak} ) \\ {X}_{2 N + K + 2} ( {f}_{peak} ) & {X}_{2 N + K + 1} ( {f}_{peak} ) & … & {X}_{2 N + 3} ( {f}_{peak} ) & {X}_{2 N + 2} ( {f}_{peak} ) \\ ⋮ & ⋮ & ⋱ & ⋮ & ⋮ \\ {X}_{3 N} ( {f}_{peak} ) & {X}_{3 N - 1} ( {f}_{peak} ) & … & {X}_{3 N - K + 1} ( {f}_{peak} ) & {X}_{3 N - K} ( {f}_{peak} ) \\ {X}_{3 N + K + 1} ( {f}_{peak} ) & {X}_{3 N + K} ( {f}_{peak} ) & … & {X}_{3 N + 2} ( {f}_{peak} ) & {X}_{3 N + 1} ( {f}_{peak} ) \\ {X}_{3 N + K + 2} ( {f}_{peak} ) & {X}_{3 N + K + 1} ( {f}_{peak} ) & … & {X}_{3 N + 3} ( {f}_{peak} ) & {X}_{3 N + 2} ( {f}_{peak} ) \\ ⋮ & ⋮ & ⋱ & ⋮ & ⋯ \\ {X}_{4 N} ( {f}_{peak} ) & {X}_{4 N - 1} ( {f}_{peak} ) & … & {X}_{4 N - K + 1} ( {f}_{peak} ) & {X}_{4 N - K} ( {f}_{peak} )\end{matrix} ] \begin{matrix}\} \\ \} \\ \} \\ \}\end{matrix} \begin{matrix} \\ \\ {Y}_{1} ( 1 ) \\ \\ \\ \\ {Y}_{1} ( 2 ) \\ \\ \\ \\ \\ {Y}_{2} ( 1 ) \\ \\ \\ \\ {Y}_{2} ( 2 ) \\ \\ \end{matrix} & ( 17 )\end{matrix}$$

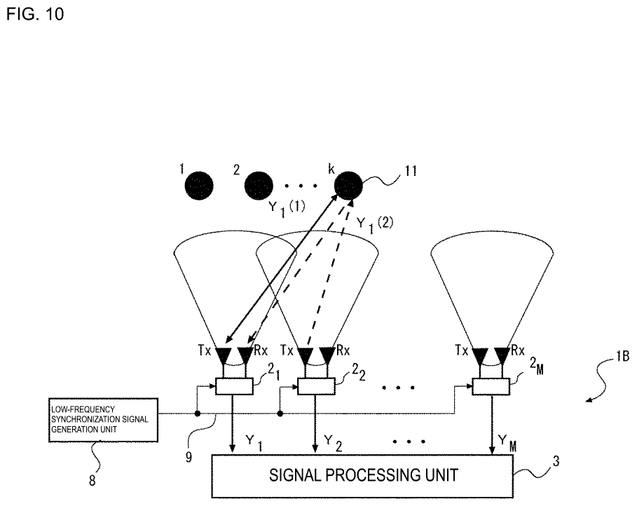

Similarly to FIG. 3, FIG. 10 illustrates the positioning system 1B having the M radars 2 (where M is the integer equal to or larger than 2). As illustrated in FIG. 10, in the positioning system 1B, the low-frequency synchronization signal generation unit 8 provides the respective radars 2₁, 2₂, . . . 2_{M} with the low-frequency synchronization signals at the plurality of points (M points). Note that in FIG. 10, the same reference numerals are assigned to the same or corresponding parts as those in FIG. 3 and FIG. 7, and a description thereof will be omitted.

In the positioning system 1B illustrated in FIG. 10, in addition to performing the operations of the positioning system 1A in the first exemplary embodiment, the respective radars 2₁, 2₂, . . . 2_{M} perform mutual transmission and reception, that is, operate in multistatic manner, thereby forming more virtual antennas than in the positioning system 1A according to the first exemplary embodiment. When the number of virtual antennas formed by one radar 2 is N, and the M radars 2 operate in multistatic manner, N×M virtual antennas are formed in the positioning system 1A according to the first exemplary embodiment, while N×M² virtual antennas are formed in the positioning system 1B according to the second exemplary embodiment.

For example, in the positioning system 1B illustrated in FIG. 10, the antenna data Y₁(1), Y₁(2), . . . Y₁(M), expressed as in the following expression (18), is formed by transmission signals being emitted from the transmitting antennas Tx of the respective radars 2₁, 2₂, . . . 2_{M} and reflected wave from the target 11 being received by the receiving antenna Rx of the radar 2₁.

$$\begin{matrix}[ MATHEMATICAL EXPRESSION 15 ] & \\ \begin{matrix}{Y}_{1} ( 1 ) = [ {X}_{1} ( {f}_{peak} ) , {X}_{2} ( {f}_{peak} ) , … , {X}_{N} ( {f}_{p e a k} ) ] \\ {Y}_{1} ( 2 ) = [ {X}_{N + 1} ( {f}_{peak} ) , {X}_{N + 2} ( {f}_{peak} ) , … , {X}_{2 N} {f}_{peak} ) ] \\ ⋮ \\ {Y}_{1} ( M ) = [ {X}_{N ( M - 1 ) + 1} ( {f}_{peak} ) , {X}_{N ( M - 1 ) + 2} ( {f}_{peak} ) , … , {X}_{NM} ( {f}_{peak} ) ]\end{matrix} \} & ( 18 )\end{matrix}$$

Here, as illustrated in FIG. 10, the antenna data Y₁(1) is data formed by radio waves emitted from the radar 2₁ and received by the radar 2₁, the antenna data Y₁(2) is data formed by radio waves emitted from the radar 2₂ and received by the radar 2₁, and the antenna data Y₁(M) is data formed by radio waves emitted from the radar 2 and received by the radar 2₁. In addition, the antenna data Y₂(1) is data formed by radio waves emitted from the radar 2₁ and received by the radar 2₂, the antenna data Y₂(2) is data formed by radio waves emitted from the radar 2₂ and received by the radar 2₂, and the antenna data Y₂(M) is data formed by radio waves emitted from the radar 2_{M} and received by the radar 2₂. In addition, the antenna data Y_{M}(1) is data formed by radio waves emitted from the radar 2₁ and received by the radar 2_{M}, the antenna data Y_{M}(2) is data formed by radio waves emitted from the radar 2₂ and received by the radar 2_{M}, and the antenna data Y_{M}(M) is data formed by radio waves emitted from the radar 2_{M} and received by the radar 2_{M}.

As such, the number of the virtual antennas formed by the M radars is N×M², because the number of the virtual antennas formed by the one radar 2₁ is N×M.

With such a positioning system 1B according to the second exemplary embodiment, all that is needed is synchronization of timing of transmission and reception between the respective radars 2₁ and 2₂. For this reason, as illustrated in FIG. 10, a transmission signal outputted from one radar 2 of the respective radars 2₁, 2₂, . . . , 2_{M} can be received by other radars 2. Thus, the number of the virtual antennas obtained by the respective radars 2₁, 2₂, . . . , 2_{M} increases as described above.

Therefore, in the convolution matrix C used in the AF method, more antenna data is stacked in the row direction of the matrix. Consequently, the number of the simultaneous equations expressed in the expression (9) by using the matrix product of the convolution matrix C and the filter coefficient vector H increases more, and the filter coefficient vector H is expressed with higher precision. More specifically, in the general positioning system, the precision of the simultaneous equations illustrated in the expression (9) deteriorates, because the relation between the estimated number of waves K in the expression (7) and the number of antennas N is the underdetermined problem at K>(N−1)/2. However, also in the positioning system 1B according to the present exemplary embodiment, this condition is eased by stacking the antenna data in the row direction of the plurality of rows, which thus improves the precision of estimation. Therefore, the phase difference wₖ between the antennas is calculated with higher precision, from the filter coefficient vector H expressed with higher precision. This enables the angle estimation of the target 11 to be performed with higher angular resolution. However, similarly to the first exemplary embodiment, the condition is that the target position does not change between the acquisition of the respective antenna data.

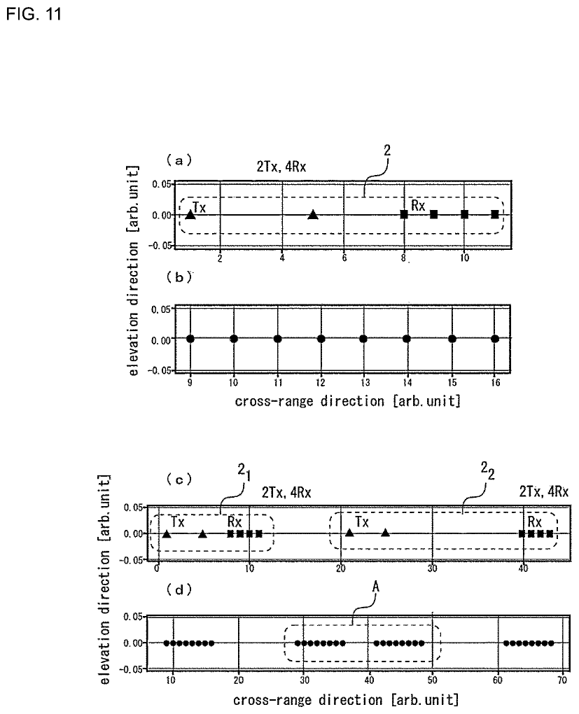

The graphs in FIG. 11(a) and FIG. 11(b) illustrate simulation results of the virtual antennas formed by the MIMO processing for the one radar 2 (monostatic radar). In each of these graphs, the horizontal axis represents a position in a cross-range direction, and the vertical axis represents a position in an elevation direction. In the graph in FIG. 11(a), the two transmitting antennas Tx of the one radar 2 are represented by triangles, and the four receiving antennas Rx are represented by squares. In the graph of FIG. 11(b), the virtual antennas formed by these two transmitting antennas Tx and four receiving antennas Rx are represented by circles. As illustrated in the graphs in FIG. 11(a) and FIG. 11(b), the number of the virtual antennas formed by the two transmitting antennas Tx and the four receiving antennas Rx in the one radar 2 is 8=(2×4).

The graphs in FIG. 11(c) and FIG. 11(d) illustrate the simulation results of virtual antennas formed by the MIMO processing for the two radars 2₁, 2₂, (bistatic radars). In each of these graphs, the horizontal and the vertical axes are the same as those in the graphs of FIG. 11(a) and FIG. 11(b). In the graph in FIG. 11(c), the two transmitting antennas Tx of the two radar 2₁ and 2₂ are represented by triangles, and the four receiving antennas Rx are represented by squares. In the graph of FIG. 11(d), the virtual antennas formed by two sets of these two transmitting antennas Tx and four receiving antennas Rx are represented by circles. As illustrated in the graphs in FIG. 11(c) and FIG. 11(d), the number of the virtual antennas formed by the two sets of the two transmitting antennas Tx and the four receiving antennas Rx in the two radar 2₁ and 2₂ is 32=(8×2²). The two radars 2₁ and 2₂ operating in a bistatic manner has increased the virtual antennas to 16 as illustrated in a frame A.

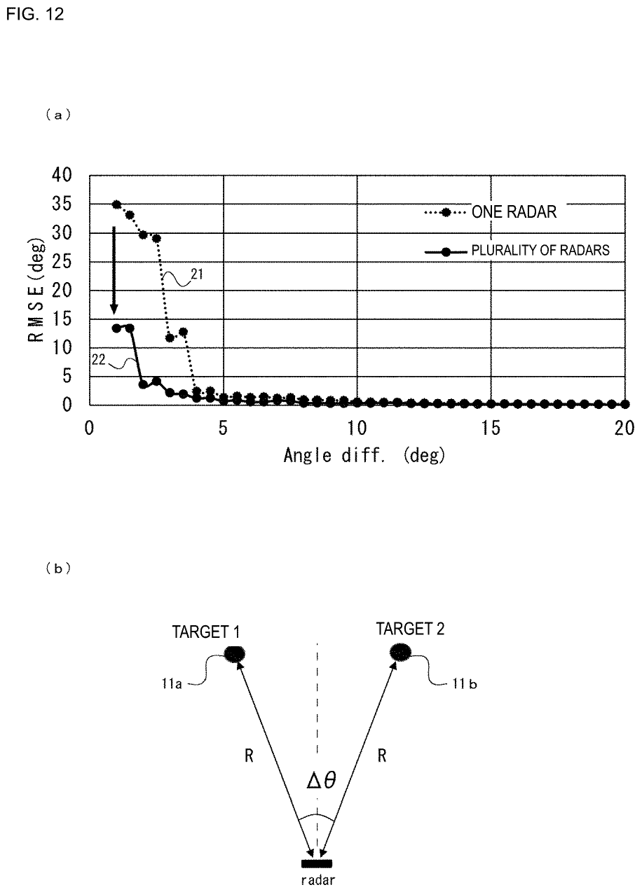

The graph in FIG. 12(a) illustrates a result of a comparison between RMSE (Root Mean Squared Error) of the angle estimation by a monostatic radar (single radar) as illustrated in FIG. 11(a) and the RMSE of the angle estimation by a bistatic radar (plurality of radars) as illustrated in FIG. 11(c), when a change is made to the difference in the installation angles of the two targets. The horizontal axis of the graph in FIG. 12(a) represents the difference 40 in the installation angles of the two targets, which are a target 11a and a target 11b, illustrated in a plan view of FIG. 12(b). The vertical axis of the graph in FIG. 12(a) represents the RMSE. In addition, a characteristic line 2₁ connecting each plot by a dotted line depicts the result of simulating the RMSE in the angle estimation by the monostatic radar, and a characteristic line 2₂ connecting each plot by solid lines depicts the result of simulating the RMSE in the angle estimation by the bistatic radar. RMSE is a root-mean-square of a difference between a true value and a measured value. Thus, the smaller the value is, the more accurate the RMSE is.

As illustrated in the graph in FIG. 12(a), the plot of the characteristic line 2₂ is at a position with smaller RMSE than the characteristic line 2₁, and it can be seen that the angle estimation by the bistatic radar has a higher degree of accuracy. It is also understood from the graph in FIG. 12(a) that the angular resolution is improved from approximately 5 deg (RMSE=2.5 deg) for the monostatic radar to approximately 3.5 deg (RMSE=1.75 deg) for the bistatic radar, if judging is based on the point where the RMSE on the vertical axis coincides with half of the angle difference between the two targets, which is the value on the horizontal axis, for example.

Next, a description will be given of a positioning system according to a third exemplary embodiment of the present disclosure.

The positioning system according to the third exemplary embodiment differs from the positioning system 1B according to the second exemplary embodiment in that the transmitting antennas Tx and the receiving antennas Rx of the respective radars 2₁, 2₂, . . . , 2_{M} are disposed so that physical distances D between the transmitting antennas Tx and the receiving antennas Rx are different from each other. For any other point, the positioning system according to the third exemplary embodiment is similar to the positioning system 1B according to the second exemplary embodiment.

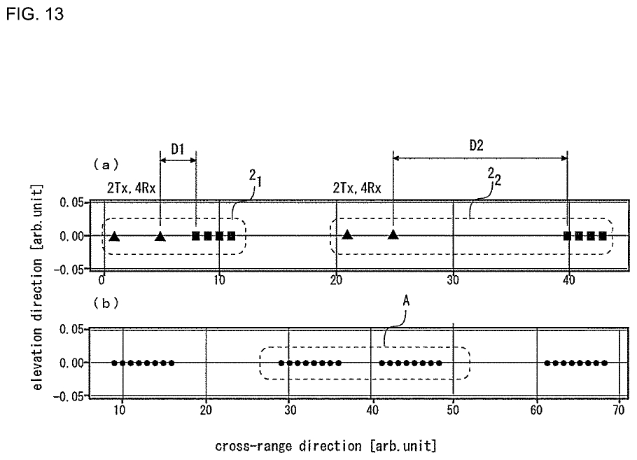

The graphs in FIG. 13(a) and FIG. 13(b) illustrate the simulation results of the MIMO processing for the two radars 2₁ and 2₂ in the positioning system according to the third exemplary embodiment. In each of these graphs, the horizontal and the vertical axes are the same as those in the graphs of FIG. 11(a) and FIG. 11(b). In the graph in FIG. 13(a), the two transmitting antennas Tx of the two respective radars 2₁ and 2₂ are represented by triangles, and the four receiving antennas Rx are represented by squares. The physical distance D between the transmitting antenna Tx and the receiving antenna Rx of the radar 2₁ is D1, and the physical distance D between the transmitting antenna Tx and the receiving antenna Rx of the radar 2₂ is D2. D1 and D2 are set to different distances (D1≠D2).

In the graph of FIG. 13(b), the virtual antennas formed by two sets of these two transmitting antennas Tx and four receiving antennas Rx are represented by circles. As illustrated in the graphs in FIG. 13(a) and FIG. 13(b), the number of the virtual antennas formed by the two radars 2₁ and 2₂, in which the physical distance D1 and the physical distance D2 between the transmitting antenna Tx and the receiving antenna Rx are set to the different distances, is 32(=8×2²). The two radars 2₁ and 2₂ operating in a bistatic manner has increased the virtual antennas to 16 as illustrated in a frame A.

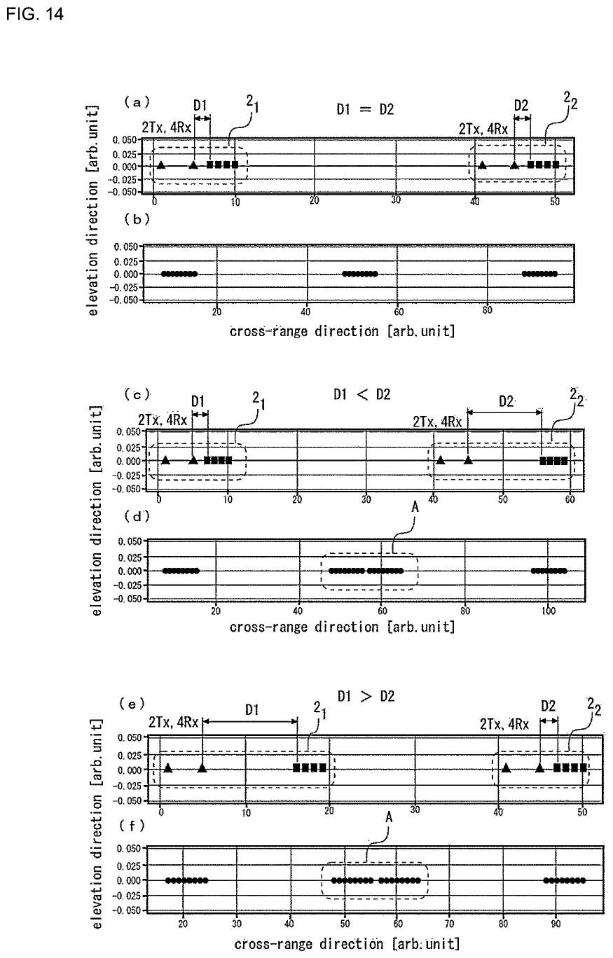

The graphs in FIG. 14(a) and FIG. 14(b) illustrate the simulation results of the MIMO processing for the two radars 2₁ and 2₂ where the physical distance D1 and the physical distance D2 between the transmitting antenna Tx and the receiving antenna Rx is set to same distances (D1=D2). The graphs in FIG. 14(c) and FIG. 14(d) illustrate the simulation results of the MIMO processing for the two radars 2₁ and 2₂ where the physical distance D1 between the transmitting antenna Tx and the receiving antenna Rx in the radar 2₁ is shorter than the physical distance D2 between the transmitting antenna Tx and the receiving antenna Rx in the radar 2₂ (D1<D2). The graphs in FIG. 14(e) and FIG. 14(f) illustrate the simulation results of the MIMO processing for the two radars 2₁ and 2₂ where the physical distance D1 between the transmitting antenna Tx and the receiving antenna Rx in the radar 2₁ is longer than the physical distance D2 between the transmitting antenna Tx and the receiving antenna Rx in the radar 2₂ (D1>D2).

In each of these graphs, the horizontal and the vertical axes are the same as those in the graphs of FIG. 11(a) and FIG. 11(b). In addition, In the same figure, the same reference numerals are assigned to the same or corresponding parts as those in FIG. 13, and a description thereof will be omitted.

In the two radars 2₁ and 2₂ the simulation results of which are illustrated in FIG. 14(a) and FIG. 14(b) and whose physical distances D1 and D2 are set to the same distance (D1=D2), the number of the virtual antennas is 24. However, in the two radars 2₁ and 2₂ the simulation results of which are illustrated in FIG. 14(c) and FIG. 14(d) and where the physical distance D1 is shorter than the physical distance D2 (D1<D2) and in the two radars 2₁ and 2₂ the simulation results of which are illustrated in FIG. 14(e) and FIG. 14(f) and where the physical distance D1 is longer than the physical distance D2 (D1>D2), the number of the virtual antennas is 32. The number of the virtual antennas has increased than the case of the two radars 2₁ and 2₂ where the physical distance D1 and the physical distance D2 are set to the equal distance (D1=D2).

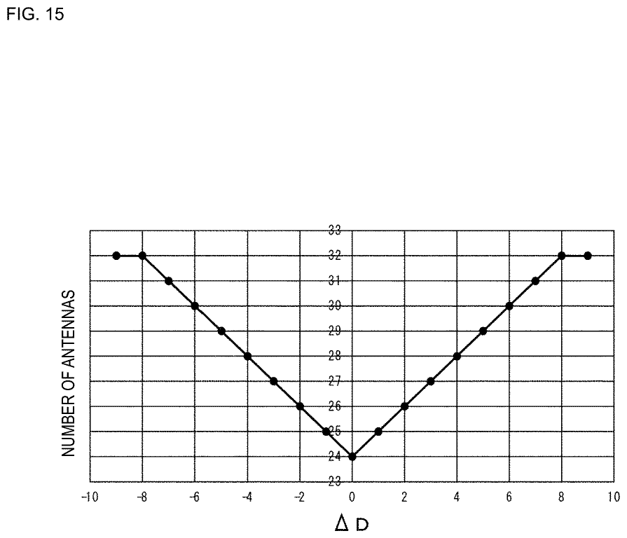

The graph in FIG. 15 illustrates the simulation results of the number of virtual antennas obtained when a distance difference ΔD between the physical distance D1 and the physical distance D2 between the transmitting antennas Tx and the receiving antennas Rx of the two sets of the radars 2₁ and 2₂ is changed. The horizontal axis of the graph in FIG. 15 represents the distance difference ΔD between the physical distance D1 and the physical distance D2, and the vertical axis represents the number of the virtual antennas.

From the graph in FIG. 15, the number of the virtual antennas is at a minimum when the distance difference ΔD=0, and increases when the distance difference ΔD≠0. More specifically, with the positioning system according to the third exemplary embodiment in which the physical distance D1 and the physical distance D2 are set to the different distances, the number of the virtual antennas increases. However, the radar 2₁ and the radar 2₂ being separate modules, it is based on the premise that they are sufficiently far apart when compared to the physical distances D1 and D2. The premise is reasonable in consideration of actual use of the radars 2₁ and 2₂.

With the positioning system according to the third exemplary embodiment described above, the number of the virtual antennas obtained by the respective radars 2₁, 2₂, . . . , 2_{M} is further increased when compared to the positioning system 1B according to the second exemplary embodiment. Therefore, the number of the simultaneous equations expressed in the expression (9) by using the matrix product of the convolution matrix C and the filter coefficient vector H is further increased, and the filter coefficient vector H is expressed with higher precision. Therefore, the phase difference wₖ between the antennas is calculated with higher precision, from the filter coefficient vector H expressed with higher precision. This enables the angle estimation of the target 11 to be performed with higher angular resolution. However, similarly to the first and second exemplary embodiments, the condition is that the target position does not change between the acquisition of the respective antenna data.

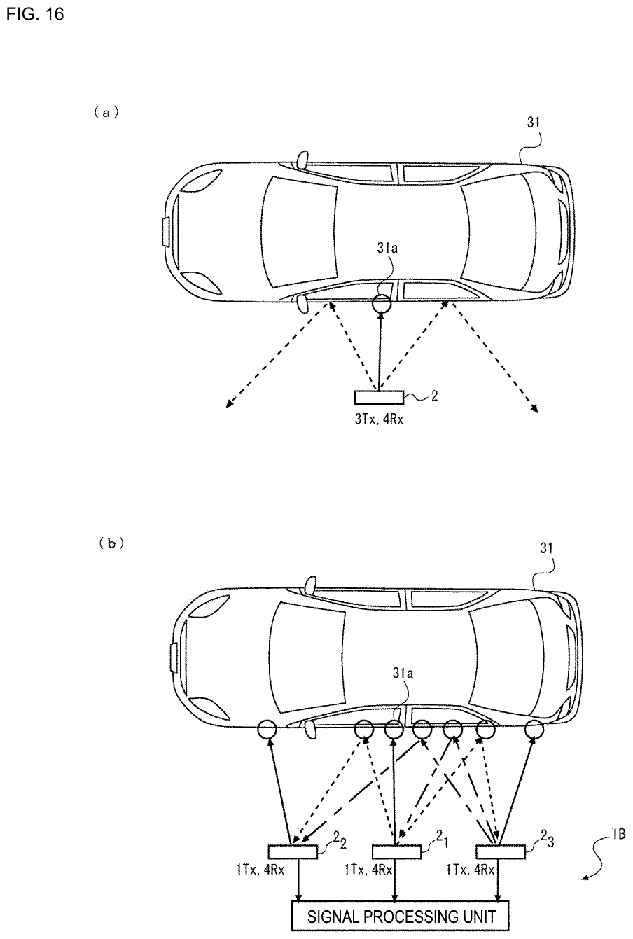

FIG. 16 is a diagram explaining effects of the positioning system 1B according to the second and third exemplary embodiments.

FIG. 16(a) illustrates a detection point 31a of a vehicle 31 that can be detected by a single radar 2 (monostatic radar) having three transmitting antennas Tx and four receiving antennas Rx. FIG. 16(b) illustrates a detection point 31a of a vehicle 31 that can be detected by a plurality of radars 2₁, 2₂, 2₃ (multistatic radar) having one transmitting antenna Tx and four receiving antennas Rx.

FIG. 16(a) indicates that the single radar 2 can only receive reflected waves from the detection point 31a hit by transmission wave depicted by a solid line, and cannot receive reflected wave from the transmission wave depicted by dashed lines. FIG. 16(b) indicates that the reflected waves that can be received are not limited to the reflected waves from the detection point 31a hit by the transmission waves that are sent out from the plurality of radars 2₁, 2₂, and 2₃, and depicted by the solid lines. That is, FIG. 16(b) indicates that the reflected waves by the transmission waves that are sent out from the radar 2₁ and depicted by the dashed line are received by other radars 2₂ and 2₃, and the reflected waves by the transmission waves that are sent out from the radar 2₃ and depicted by dashed-dotted lines are received by other radars 2₁ and 2₂, which enables the detection point 31a to be recognized over a wide range of the vehicle 31. More specifically, according to the positioning system 1B having the plurality of radars 2₁, 2₂, and 2₃, a radar aperture length is increased, which enables the detection point 31a to be recognized over a wide range of the vehicle 31.

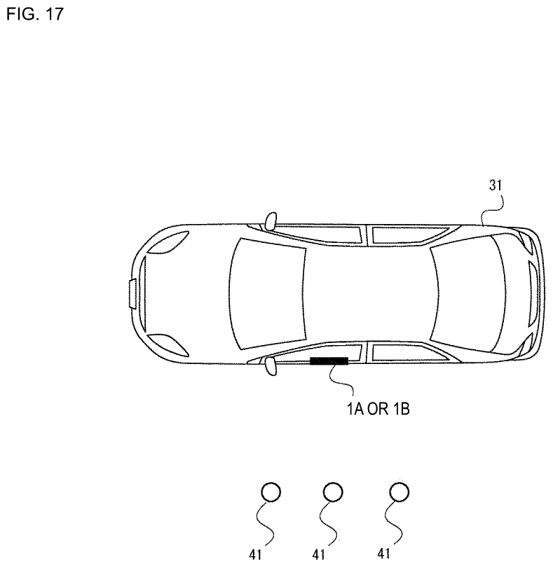

FIG. 17 is a diagram explaining effects achieved by the vehicle 31 including the positioning system 1A or 1B according to the first, second, or third exemplary embodiment. In this example, the vehicle 31 includes the positioning system 1A or 1B on a door. Therefore, the vehicle 31 can recognize a plurality of poles 41 or the like that are spread around the vehicle 31, for example, and tell a driver to be careful when starting. According to the configuration, the vehicle 31 can include the positioning system 1A or 1B that can estimate the angle of the target such as the poles 41, or the like, with high angular resolution.

Note that each of the exemplary embodiments described above explains the case in which the transmitter/receiver is the radar. However, the transmitter/receiver is not limited to the radar and may be a transceiver, or the like. Even in such a case, workings and effects similar to those of the respective exemplary embodiments described above can be achieved.

In addition, each of the exemplary embodiments described above explains the case in which the signal processing unit is provided separately from the radars. However, a configuration may be such that a radar includes a signal processing unit or a radar includes some of a signal processing unit. Also in such a case, workings and effects similar to those of the respective exemplary embodiments described above can be achieved.

### REFERENCE SIGNS LIST

1A, 1B Positioning system
2, 2₁, 2₂, . . . 2_{M} Radar (Transmitter/Receiver)
3 Signal processing unit
4 Transmitter/receiver
4a Low-frequency synchronization signal input terminal
5 RF signal generation unit
6 Mixer
7 ADC (Analog-to-digital converter)
8 Low-frequency synchronization signal generation unit
9 Cable
11 Target
Tx Transmitting antenna
Rx Receiving antenna

1. A positioning apparatus comprising:
a first transceiver transmitting and receiving a radio wave; and
a signal processing circuitry receiving a signal from the transceiver, wherein
the first transceiver includes a first transmitter including a plurality of transmitting antennas for transmitting radio waves and a first receiver including a plurality of receiving antennas for receiving reflected waves.

2. The positioning apparatus according to claim 1, further comprising:
a second transceiver, wherein
the second transceiver includes a second transmitter including a plurality of transmitting antennas for transmitting radio waves and a second receiver including a plurality of receiving antennas for receiving reflected waves from a target, and
the signal processing circuitry is connected to the first transceiver and the second transceiver.

3. The positioning apparatus according to claim 1 further comprising
a mixer that mixes a transmission signal and a reception signal to generate an intermediate frequency signal, and
synchronization signal generation circuitry that synchronizes signal processing in a frequency band of the intermediate frequency signal between the first transceiver and the second transceiver.

4. The positioning apparatus according to claim 3, further comprising:
an analog-to-digital converter (ADC) in the first transceiver, wherein the ADC converts the intermediate frequency signal to a digital signal and output to the signal processing circuitry.

5. The positioning apparatus according to claim 3, wherein in the first transceiver, a physical distance between the first transmitter and first receiver is different from a physical distance between the second transmitter and second receiver.

6. The positioning apparatus according to claim 5, wherein the physical distance between the first transmitter and first receiver is smaller than the physical distance between the second transmitter and second receiver.

7. The positioning apparatus according to claim 5, wherein the physical distance between the first transmitter and first receiver is larger than the physical distance between the second transmitter and second receiver.

8. A positioning system comprising
a vehicle,
a positioning apparatus including
a first transceiver transmitting and receiving a radio wave and
signal processing circuitry,
wherein the positioning apparatus is mounted to the vehicle,
the first transceiver includes a first transmitter including a plurality of transmitting antennas for transmitting radio waves and a first receiver including a plurality of receiving antennas for receiving reflected waves.

9. The positioning system according to claim 8, further comprising:
a second transceiver, wherein
the second transceiver includes a second transmitter including a plurality of transmitting antennas for transmitting radio waves and a second receiver including a plurality of receiving antennas for receiving reflected waves from a target, and
the signal processing circuitry is connected to the first transceiver and the second transceiver.

10. The positioning system according to claim 8, further comprising:
a mixer that mixes a transmission signal and a reception signal to generate an intermediate frequency signal, and
synchronization signal generation circuitry that synchronizes signal processing in a frequency band of the intermediate frequency signal between the first transceiver and the second transceiver.

11. The positioning system according to claim 3, further comprising:
an analog-to-digital converter (ADC) in the first transceiver, wherein the ADC converts the intermediate frequency signal to a digital signal and output to the signal processing circuitry.

12. The positioning apparatus according to claim 10, wherein in the first transceiver, a physical distance between the first transmitter and first receiver is different from a physical distance between the second transmitter and second receiver.

13. The positioning apparatus according to claim 12, wherein the physical distance between the first transmitter and first receiver is smaller than the physical distance between the second transmitter and second receiver.

14. The positioning apparatus according to claim 12, wherein the physical distance between the first transmitter and first receiver is larger than the physical distance between the second transmitter and second receiver.

15. A positioning method in signal processing for estimating an angle of a target by employing an Annihilating Filter method that uses an annihilating filter, the method comprising:
generating a convolution matrix by stacking a plurality of antenna data in a row direction of a matrix and combining the antenna data, the antenna data being obtained from a plurality of transmitting antennas for transmitting radio waves and from a plurality of receiving antennas for receiving reflected waves from the target, the plurality of transmitting antennas and the plurality of receiving antennas being included in each of a plurality of transmitters/receivers;
determining a filter coefficient vector from simultaneous equations expressed by using a matrix product of the convolution matrix and a filter coefficient vector of a transfer function of the annihilating filter, with the filter coefficient vector being unknown;
calculating a phase difference between antennas from the filter coefficient vector that is determined; and
performing an operation to estimate an arrival angle of the reflected wave from the target, based on the phase difference between the antennas that is calculated.

16. The method according to claim 15, further comprising:
acquiring first antenna data from a first receiving antenna,
acquiring second antenna data from a second receiving antenna.

17. The method according to claim 15, further comprising:
calculating a relative velocity of a positioning system with respect to a target by using the Doppler frequency difference from the Doppler shift of an antenna data being obtained from a plurality of transmitting antennas for transmitting radio waves and from a plurality of receiving antennas for receiving reflected waves from a target.

18. The method according to claim 15, further comprising:
calculating a distance to a target.

19. The method according to claim 15, further comprising: performing a Constant False Alarm Rate processing to detect the peak of an intermediate frequency signal.
